(19) United States
(12) Patent Application Publication
(10) Pub. No.: US 2005/0283397 A1
(43) Pub. Date: Dec. 22, 2005

(54) Internet-based compensation analysis

(76) Inventor: Tolo M. Rimsky, Lincolnshire, IL (US)

Correspondence Address: Paul E Schaafsma, NovusIP, LLC;Suite 221, 521 West Superior, Chicago, IL, 60610, US

(21) Appl. No.: 11/133,930

(22) Filed: May 20, 2005

Related U.S. Application Data
(63) Continuation-in-part of application No. 10/765,537, filed on Jan. 27, 2004.

(51) Int. Cl. G06F 17/60

(52) U.S. Cl. 705/11

(57) ABSTRACT

A computer networked compensation analysis method in accordance with the principles of the present invention provides tools for sensitivity analysis of various compensation parameters. Particular tools can include development of a salary structure, merit increase budget control, cost of salary increases, goalsharing, and executive bonuses. With these tools, a user can analyze and perform sensitivity analysis to classify a salary structure designed specifically for a company, advise the company on how to grant increases and stay within budget, calculate the cost of different scenarios of increases for the first year and for subsequent years, and calculate bonuses to be given to individual employees, and calculate bonuses to executives.

### CROSS-REFERENCE TO RELATED APPLICATIONS

This application is a continuation-in-part to U.S. patent application Ser. No. 10/765,537 titled, “Internet-Based Compensation Survey,” filed 27 Jan. 2004.

### COPYRIGHT NOTICE

A portion of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to Internet enabled compensation analysis systems.

### BACKGROUND OF THE INVENTION

The Internet is a global network of computers. Network servers support hypertext capabilities that permit the Internet to link together webs of documents. User interfaces such as Graphical User Interfaces (GUI) are typically used to navigate the Internet to retrieve relevant documents. Uniform Resource Locators (URLs) are used to identify specific web sites and web pages on the Internet. URLs also identify the address of the document to be retrieved from a network server. The Transfer Control Protocol/Internet Protocol (TCP/IP) is used to transfer information.

The Internet uses a hypertext language referred to as the hypertext mark-up language (HTML). HTML is a commonly used scripting or programming language that permits content providers or developers to place hyperlinks within web pages. These hyperlinks link related content or data, which may be found on multiple Internet host computers. HTML document links may retrieve remote data by use of Hyertext Transfer Protocol (HTTP). Alternatively, File Transfer Protocol (FTP), Gopher, or other Internet application protocols can be used. When a user clicks on a link in a web document, the link icon in the document contains the URL that the client employs to initiate the session with the server storing the linked document. HTTP is the protocol used to support the information transfer.

While most of today's users of the Internet believe it is a recent communications phenomenon, the origins of the Internet actually go back several decades. Today's Internet grew out a computer resource-sharing network created in the 1960s by the Advanced Research Projects Agency (ARPA). This computer resource-sharing network, which came to be known as the ARPAnet, was primarily designed by ARPA's chief scientist, Larry Roberts. The initial problem facing a wide-area computer resource-sharing network was how to efficiently transmit digitized information in a reliable way. To solve this problem, in 1968, Roberts mandated use of a packet-switching design in the ARPAnet.

Packet switching breaks up blocks of digitized information into smaller pieces called packets. These packets are transmitted through the network, usually by different routes, and are then reassembled at their destination. Eight years prior to ARPA's RFP, Len Kleinrock invented packet switching. See, e.g., Len Kleinrock, “Information Flow in Large Communications Nets,” RLE Quarterly Progress Report (1960); Len Kleinrock, Communication Nets (1964). See also Paul Baren, “On Distributed Communications Networks,” IEEE Transactions on Systems (March 1964). Roberts believed that packet switching was the means to efficiently transmit digitized information in a reliable way.

The next problem to solve was how to interconnect a number of mainframe computers, most of which utilized different languages and different operating systems. Wesley Clark of Washington University in St. Louis, Mo., devised the solution to this huge incompatibility problem. Clark proposed that a smaller microcomputer should interface between every mainframe and the network. All of these minicomputers would run on the same operating system and use the same language. Each mainframe, therefore, would only be required to interface with its own minicomputer, with the minicomputer translating into the network operating system and language. These Interface Message Processors (IMP), which provided an interface between the ARPAnet host mainframe computers and the ARPAnet, were the predecessors to today's routers. With this basic design, the first two nodes on the ARPAnet communicated on 1 Oct. 1969.

By 1971, 15 nodes, mostly academic institutions, were up on the ARPAnet. However, the original goal of the ARPAnet was not being realized. Resource sharing of the mainframe computers was simply too cumbersome. In March 1972, however, Ray Tomlinson of Bolt, Beranek & Newman invented e-mail. Use of this message transfer program quickly grew to be the initial major use of the ARPAnet.

By the mid-seventies, the ARPAnet was not the only network utilizing switching packets. Once again, an incompatibility problem emerged. Each of these different networks used a different protocol. Thus, interconnection of these different networks was not possible. The solution, devised by Robert Kahn of ARPA and Vincent Cerf of Stanford University, was called the Transmission Control Protocol/Internet Protocol. The Transmission Control Protocol packetized information and reassembled the information upon arrival. The Internet Protocol routed packets by encasing the packets between networks. See, e.g., Robert Kahn and Vincent Cerf, “A Protocol for Packet Network Intercommunication,” IEEE Transactions on Communications Technology (May 1974). Transmission Control Protocol/Internet Protocol was adopted by the ARPAnet in 1983. With the addition of the Domain Name System (DNS) in November 1983, the now familiar Internet address protocol was established.

A final step in creating the Internet occurred in 1990, when an Englishman, Tim Berners-Lee of the European Center for Particle Research (CERN) in Switzerland, invented the World Wide Web. This software, based on a program Berners-Lee had written in 1980 to allow users to store information using random associations, allowed material from any computer, from any format to be translated into a common language of words, images, and addresses. Berners-Lee's program established the three core components of the World Wide Web: the Universal Resource Locator, Hypertext Transfer Protocol, and HyperText Markup language.

The initial focus of e-commerce technologies on the Internet was to facilitate business-to-consumer (B2C) transactions. This lead to a frenzy of investment into nearly any Internet related B2C idea, even where the idea lacked real merit. This investment frenzy came to an abrupt end when the Internet valuation bubble burst in March 2000: from its March 2000 high of 5,047.69, the technology rich NASDAQ stock index fell over 40%.

Increasingly, however, businesses are finding economies in transacting business-to-business (B2B) over the Internet. Thus far, however, such B2B transactions over the Internet have proven largely unsatisfactory for increasing productivity in the dissemination of information to human resource, compensation, and benefit managers, and the like.

Thus, what is needed is an automated system of dissemination of information to human resource, compensation, and benefit managers, and the like. Such a system would allow for the user to analyze human resource information quickly and efficiently in a dynamically changing environment.

### SUMMARY OF THE INVENTION

An automated system in accordance with the principles of the present invention effectively disseminates information to human resource, compensation, and benefit managers, and the like. An automated system in accordance with the principles of the present invention allows for the user to analyze human resource information quickly and efficiently in a dynamically changing environment.

A computer networked compensation analysis method in accordance with the principles of the present invention provides tools for sensitivity analysis of various compensation parameters. Particular tools can include development of a salary structure, merit increase budget control, cost of salary increases, goalsharing, and executive bonuses. With these tools, a user can analyze and perform sensitivity analysis to classify a salary structure designed specifically for a company, advise the company on how to grant increases and stay within budget, calculate the cost of different scenarios of increases for the first year and for subsequent years, and calculate bonuses to be given to individual employees, and calculate bonuses to executives.

### DESCRIPTION OF THE FIGURES

FIG. 1 is a home page graphical user interface of a business-to-business compensation analysis system in accordance with the principles of the present invention.

FIG. 2 is an options page of the business-to-business compensation analysis system of FIG. 1.

FIG. 3 is an Interpolation/Extrapolation option page of the business-to-business compensation analysis system of FIG. 1.

FIG. 4 is an example pop-up screen of the Interpolation/Extrapolation option page of FIG. 3 showing job code 1 as a human resource administrator.

FIG. 5 is an example screen of the Interpolation/Extrapolation option page of FIG. 3 showing an Industry Results for job code 1—human resource administrator in the category all companies.

FIG. 6 is a Projection option page of the business-to-business compensation analysis system of FIG. 1.

FIG. 7 is a Graphical Analysis option page of the business-to-business compensation analysis system of FIG. 1.

FIG. 8 is an example screen of the Graphical Analysis option page of FIG. 7 showing an Actual Bonuses Paid and Target Bonuses graph in the Benefits Analysis section.

FIG. 9 is an example screen of the Graphical Analysis option page of FIG. 7 showing a Company Monthly Salary graph for the for job code 1—human resource administrator in the category all companies.

FIG. 10 is an example screen of the Graphical Analysis option page of FIG. 7 showing a Company Data compared with the market Average and Quartiles graph for the for job code 1—human resource administrator in the category all companies.

FIG. 11 is an example screen of the Graphical Analysis option page of FIG. 7 showing a Company Versus Market (Graphical) graph for the for job code 1—human resource administrator in the category all companies.

FIG. 12 is an example screen of the Graphical Analysis option page of FIG. 7 showing a Company Versus Market (Tabular) graph for the for job code 1—human resource administrator in the category all companies.

FIG. 13 is a Special Programs option page of the business-to-business compensation analysis system of FIG. 1.

FIG. 14 is a Development of a Salary Structure page of the Special Programs option page of FIG. 13.

FIG. 15 is a Development of a Salary Structure results page 1046 of the Development of a Salary Structure page of FIG. 14.

FIG. 16 is a Merit Increase Budget Control page of the Special Programs option page of FIG. 13.

FIG. 17 is a merit increase budget control employees page of the Merit Increase Budget Control page of FIG. 16.

FIG. 18 is a merit increase budget control calculation page of the Merit Increase Budget Control page of FIG. 16.

FIG. 19 is a Cost of Salary Increases page of the Special Programs option page of FIG. 13.

FIG. 20 is a One Increase per Year for all Employees page of the Cost of Salary Increases page of FIG. 19.

FIG. 21 is an Employees Receive Increases at Equal Intervals page of the Cost of Salary Increases page of FIG. 19.

FIG. 22 is a Several Increases for Varying % of Employees page of the Cost of Salary Increases page of FIG. 19.

FIG. 23 is an Increases on Anniversary Dates page of the Cost of Salary Increases page of FIG. 19.

FIG. 24 is a Several Increases During the Year but for the Same People page of the Cost of Salary Increases page of FIG. 19.

FIG. 25 is a Goalsharing page of the Special Programs option page of FIG. 13.

FIG. 26 is a select measurements page of the Goalsharing page of FIG. 25.

FIG. 27 is a user enters the Performance Level and the Bonus if Levels are Exceeded of the Goalsharing page of FIG. 25.

FIG. 28 is a user enters the Actual Results of Each of the Measurements of the Goalsharing page of FIG. 25.

FIG. 29 is a user enters the Percentage of Savings of the Goalsharing page of FIG. 25.

FIG. 30 is a Goalsharing results page of the Goalsharing page of FIG. 25.

FIG. 31 is an Executive bonuses page of the special programs option page of FIG. 13.

FIG. 32 is a user enters the number of employees that participate of the Executive bonuses page of FIG. 31.

FIG. 33 is a user enters the Annual Salary of each executive and the Percentage of Salary each executive can receive as Optimal Bonus page of the Executive bonuses page of FIG. 31.

FIG. 34 is an amount of the optimal bonuses and the proportion of the total bonus funded page of the Executive bonuses page of FIG. 31.

FIG. 35 is a measurements selection page of the Executive bonuses page of FIG. 31.

FIG. 36 is an Executive bonuses results page of Executive bonuses page of FIG. 31.

### DETAILED DESCRIPTION OF THE INVENTION

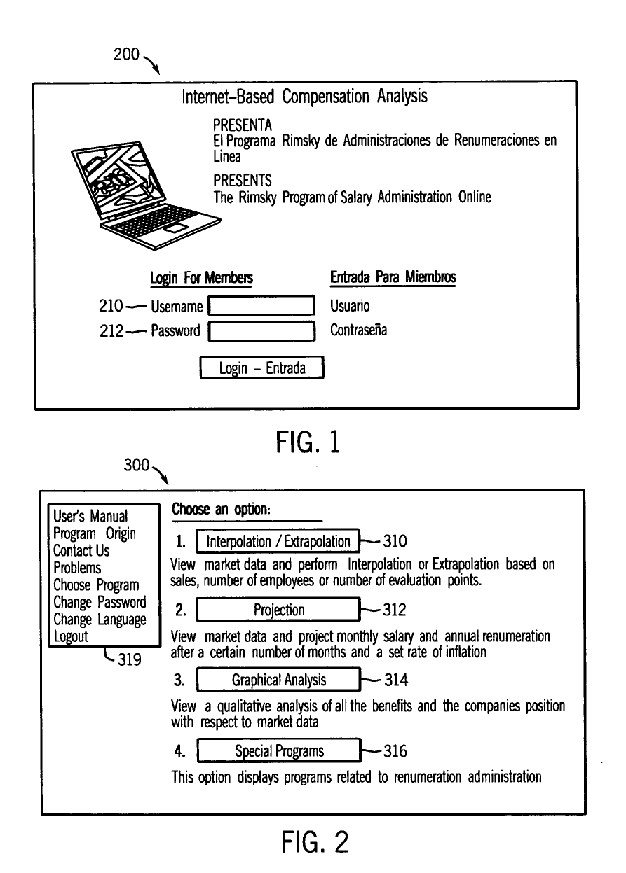

Referring to FIG. 1, a home page graphical user interface (GUI) 200 of a business-to-business compensation system in accordance with the principles of the present invention is seen. To enter the system the user must enter the web-site. Once the system opens it will ask for the Username 210 and the Password 212. A name and password can be provided to each participant to enter the system for the first time and they can continue using them, if they so wish, but they can change these at will for their exclusive use.

In one embodiment, the system can be composed of three major elements: the Web Browser, the Web Server, and the Database Server. The Web Browser is platform (e.g. Sparc™, Risc, x86) independent and operates on any software capable of displaying HTML files such as Internet Explorer from Microsoft Corporation of Redmond, Wash. or Netscape Communicator from Netscape Communications Corporation of Mountain View, Calif. The Web Server may be hosted on a network of server engines. These server engines can be Intel-based server systems available from Intel Corporation of Santa Clara, Calif. running on a Microsoft Windows NT Server operating system available from Microsoft Corporation using Enterprise Webserver software from Netscape Communications Corporation. Each of these components may be hosted on separate machines, each of which may be a component of a server farm. Alternative computer systems consisting of one or more computers employing different forms of operating systems and application systems may be used to host the system of the present invention.

In one embodiment, after entering the system, the user will find a page that asks which is the preferred language. In one embodiment, the choices can be Spanish or English. Next an options page 300 can be opened that asks for an option to be selected. The options page is seen in FIG. 2. In one embodiment, the options include Interpolation/Extrapolation 310, Projection 312, Graphical Analyses 314 and Special Programs 316. On the left side of the option page there can be a table 319 providing additional resources. In a preferred embodiment, the additional resources include User's Manual; Program Origin; Contact us; Problems—procedures to follow; Choose Program—the same options that appear at the right; Change Password; Change Language—to switch from one language to the other; and Logout. The options provided on the options page 300 provide market data for the job selected, but each offers an additional feature, as explained below.

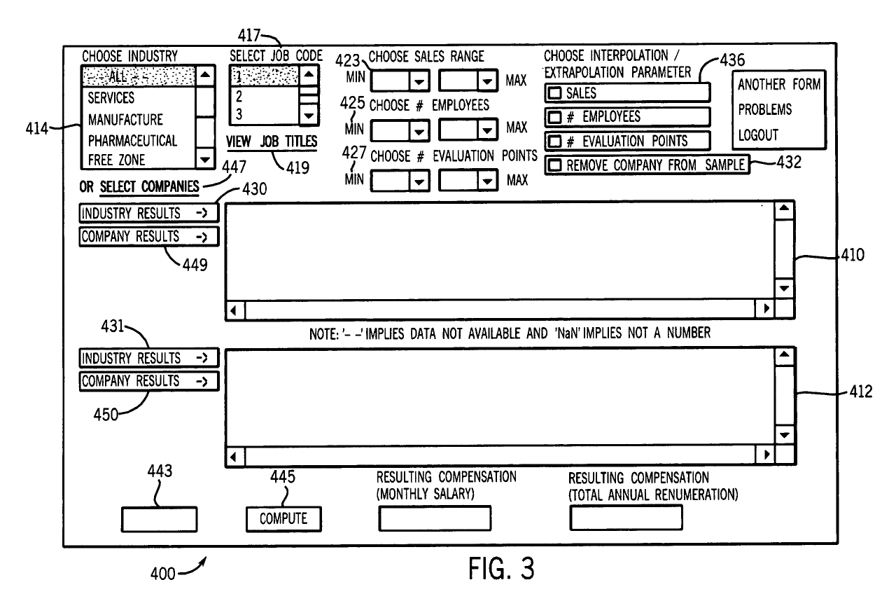

In one embodiment, the first option can be the Interpolation/Extrapolation option. The Interpolation/Extrapolation option allows the user to view market data and perform Interpolation or Extrapolation based on sales, number of employees, or number of evaluation points. Referring to FIG. 3, the Interpolation/Extrapolation option page 400 is seen.

When an option is selected the screen will show two rectangles 410, 412, where the data for the required position will appear. Before selecting a job, the user must select the industry to which he/she wishes the company to be compared. The different industries appear in the upper left part of the screen 414. In a preferred embodiment, the industries can include services, manufacturing, pharmaceutical, free zone, commercial (not shown), insurance (not shown), banking (not shown), and other industries as may appear, as well as classification of industries by geographical locations, and combinations thereof. If preferred, the comparison can be with all participants at once.

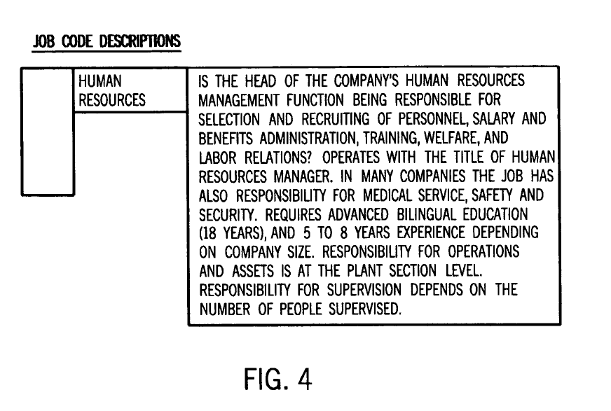

The next selection is the job to be researched. The jobs can be codified 417, but immediately below the job codes the user can find the titles of the jobs surveyed 419. The descriptions of the jobs pop-up when the cursor is moved next to the job code and then moved to the job title. For example, referring to FIG. 4, a pop-up screen showing the job code 1 as a human resource administrator, including a job description, is seen.

Referring back to FIG. 3, the user can select the market to be compared. In the preferred embodiment, the market to be compared can also be selected by Sales Range 423, by Number of Employees 425, or by Evaluation Points 427. The user selects a minimum and a maximum number of sales, employees, and/or evaluation points, and the comparison can be limited to the companies that are within those parameters.

The selection of market to be compared does not have to be limited to one of the parameters. The system of the present invention combines selections and makes comparisons to companies within those parameters, such as manufacturing companies with sales between X and Y; provided, however, that the more parameters are selected the more the data is diluted.

Each of the surveyed jobs can be evaluated as per a number of factors. In a preferred embodiment, these factors include education, experience, responsibility for operations, responsibility for company profit and loss, responsibility for supervision, and working conditions including hazards. The users can be informed of the point values assigned to their jobs via e-mail by request.

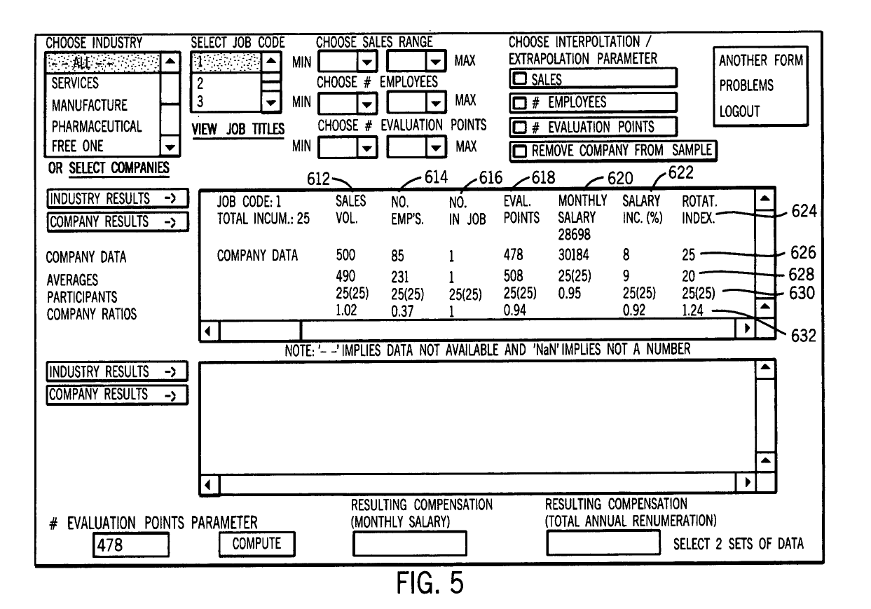

When the market to be compared has been selected, the user clicks on the box Industry Results 430. Upon doing this, the code of the job being researched will appear as will the total number of incumbents in the job for which data was gathered. For example, FIG. 5 shows this information for job code 1—human resource administrator in the category all companies. The total number of incumbents in the job may be higher than the number of participating companies because there can be many jobs that have more than one participant. Opposite this number there can be a line showing the values being presented.

In a preferred embodiment, these values include Annual Sales Volume 612, Number of Employees in the Company 614, Number of People in the Job 616, Evaluation Points 618, Monthly Salary 620, Percentage of Salary Increase Granted 622, Rotation Index 624, Validity of the Data in Months (counted from last increase) (not shown), Profit Sharing (not shown), Days of Christmas Pay (not shown), Christmas Pay in Money (not shown), Vacation Days (not shown), Vacation Bonus Days (not shown), Vacation Bonus in Money (not shown), Performance Bonus (not shown), Variable Pay in Months (not shown), Variable Pay in Money (not shown), Target Variable Pay in Months (not shown), Target Variable Pay in Money (not shown), Incentives and Commissions (not shown), Stock Sale in Months (not shown), Stock Sale in Money (not shown), Stock Cession in Month (not shown), Stock Cession in Money (not shown), Stock Options in Months (not shown), Stock Options in Money (not shown), Other Cash Income (not shown), Value of Company Car Benefit (not shown), Vehicle Expenses (not shown), Transportation Allowance (not shown), Percentage of Food Allowance (not shown), Food Allowance in Money (not shown), Value of Medical Insurance (not shown), Value of Dental Insurance (not shown), Value of Life Insurance (not shown), Percentage of Contribution to Pension (not shown), Annual Value of Pension (not shown), Cellular Bonus (not shown), Percentage of Saving Fund (not shown), Saving Fund in Money (not shown), Annual Value of Loans (not shown), Company Products (not shown), Educational Bonus (not shown), Annual Value of Medical Check-Up (not shown), Use of Company Credit Card (not shown), Annual Value of Clubs (not shown), Annual Cash Remuneration (not shown), Total Non Taxable Remuneration (not shown), Grossed-Up Non Taxable Remuneration (not shown), and Total Annual Remuneration (not shown). Some of the values presented vary from country to country, following what is usual in those countries. Examples of these are guaranteed and variable remediation or total monthly compensation.

For each job the system will preferably display four lines. The first line contains the Data of the Company 626 that is using the system. These data appears automatically the moment the user enters his/her name and password. Nobody else has access to this information. The second line shows the Market Averages 628 for each of the elements mentioned above. The third line is the Number of Participants 630 that provided data for the particular element, with the Number of Incumbents affected by that element in parenthesis. The fourth line is the Proportion of Company Ratios with respect to the Market Averages 632. When a company does not report certain elements and these do not exist in the market, the proportion appears as NaN, indicating that a proportion cannot be established. When data is not available, the designation “--” appears.

In accordance with one embodiment of the present invention, the reported values of the company can be secured through a personal interview with a responsible company representative to ensure the proper matching of jobs. The title with which the company identifies the job is not determinative of the category into which the position will be classified: rather, the job can be classified with jobs of similar content. When more than one incumbent is in a job the information requested can be the average of all incumbents or a representative figure of the group. Each company receives a diskette that contains its information, which can be easily updated in the future. In a preferred embodiment, the updating of the information is made upon receipt of fresh data.

The number of months that the data is valid can be measured from the time the employee received the last salary increase. This is the most effective way of establishing how long the data has existed in the market. As for the target bonuses, in one embodiment companies can specify the number of months of salary an employee can receive in the way of bonus. In the Analysis of Benefits which is discussed below, a relationship between the actual bonus received and the target bonus is seen.

In accordance with a preferred embodiment of the present invention, the benefits can be valued according to what the benefits would cost the employee to secure on his/her own, not on what the company pays for them. This pricing can be done on the basis of market studies made among insurance companies, automobile vendors, clubs and typical restaurants where employees could obtain their food.

In a preferred embodiment, if the user desires the values of his/her company can be removed from the market averages. To remove the company values, the user clicks on the square that says “Remove Company from Sample” 432 and clicks again the line that reads Industry 430. A new set of figures will appear, which will not include the company data.

The lower rectangle 412 can be used to display a new set of data. This new set of data allows a comparison between both sets of data. This new set of data allows also for interpolation or extrapolation of the information.

For example, a user may select for the upper rectangle data on companies up to 200 million in sales and for the lower rectangle companies with over 200 million in sales. To effectuate this, the user clicks Industry 430, 431 in front of the rectangles 410, 412, each with the different employee ranges. If the user does not elect different parameters, the lower rectangle will show the same values as the upper rectangle.

When there are two different sets of data it is possible to interpolate or extrapolate information. For example, assume a user desires information for a sales volume of 550. If the average remuneration for an average sales volume of 450 is available, and the average remuneration for an average sales volume of 620 is also available, it is possible to interpolate information what should be the remuneration for a sales volume of 550. The information for a sales volume of 550 will be the result of the interpolation between both remuneration values. The system of the present invention does this automatically upon selection of the option Sales 436 in the rectangle that says Interpolation/Extrapolation 434 in the upper right part of the screen.

The interpolation/extrapolation can be by Sales 436, by Number of Employees 438 or by Evaluation Points 441. When selecting one of these options the company number will immediately appear in the lower left part of the screen. These numbers, however, can be changed at will. Then, upon pressing Compute 445, the interpolated numbers for Monthly Salary and Total Annual Remuneration will appear.

In accordance with the present invention, the interpolation or extrapolation is an approximation, but it is not based on solid principles of remuneration management. In addition, in markets there can be frequent anomalies that can result in the interpolation and extrapolation feature not being possible. For example, a typical anomaly is when for a certain volume of sales there is a remuneration available, but for a higher volume of sales the market shows a lower remuneration. In these cases the system of the present invention will send a message saying that there is an anomaly.

If the user does not want to be compared with a certain industry in particular or with companies of a certain size regarding sales, number of employees, or evaluation points, the user can select a special group of companies with which to be compared. To implement this feature, the user clicks the line Select Companies 447 and the list of all participating companies appears. From that list the user selects the companies of interest. In order to preserve the confidentiality of any individual company, the user must select a minimum of five companies. If less than five companies are selected a message will appear reminding him/her that a minimum of five is required. Once the selection of companies is made, the use goes to the end of the list of companies, clicks the line that reads Submit List, and then the window closes.

After selecting the special universe of companies, the user clicks opposite any of the two rectangles the line that reads Companies 449, 450 instead of industries. The market data corresponding to the selected companies can be shown, just as before the data for certain industry or for a certain range of sales, employee number, or evaluation points appears.

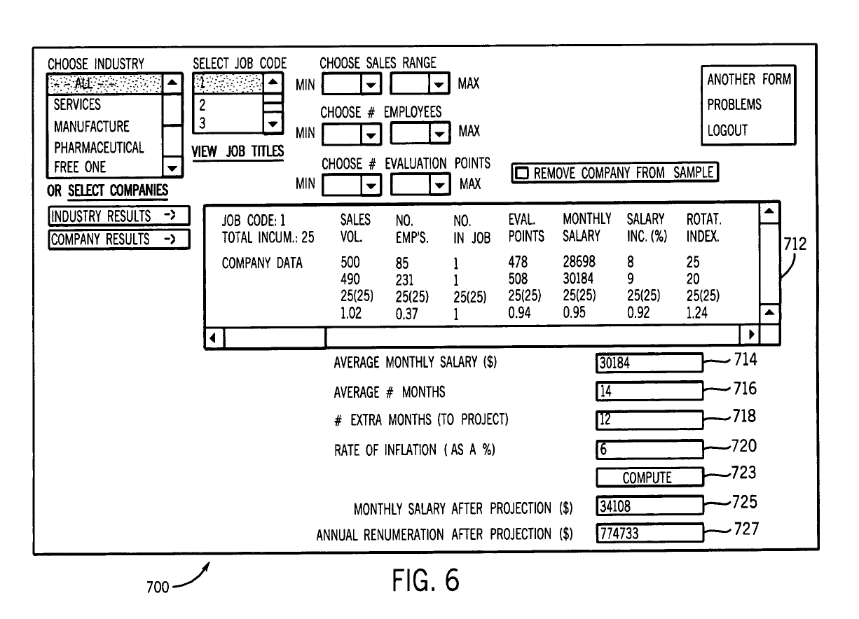

In the preferred embodiment, the second option can be the Projection option. The Projection option enables the user to view market data and project monthly salary and annual remuneration after a certain number of months and a set rate of inflation. Referring to FIG. 6, the Projection option page 700 is seen. For ease of reference, a discussion of like elements from the Interpolation/Extrapolation option page 400 will not be repeated for each remaining figure.

As with the Interpolation/Extrapolation option, the Projection option shows the market values, but in addition it can project numbers to a future date. When selecting a group of companies to be compared, the data appears in a rectangle 712, just as the Interpolation/Extrapolation option. Immediately below the data rectangle, the average market value of monthly salary 714 and the number of months the data has been in existence in the market by the time it was processed 716 are seen (these can be the same numbers that appear in the corresponding columns of the data rectangle).

Immediately below this information there can be a space that asks how many more months the data is to be projected 718 and another space that asks for an estimate on the inflation for the period 720. Once this information is entered the user clicks Compute 723 and the Monthly Salary 725 as well as the Annual Remuneration 727 projected to the desired date will appear.

For example, the Projection option page 700 of FIG. 6 shows this information for job code 1—human resource administrator in the category all companies, with the number of extra months set at 12 and the rate of inflation set at 6%.

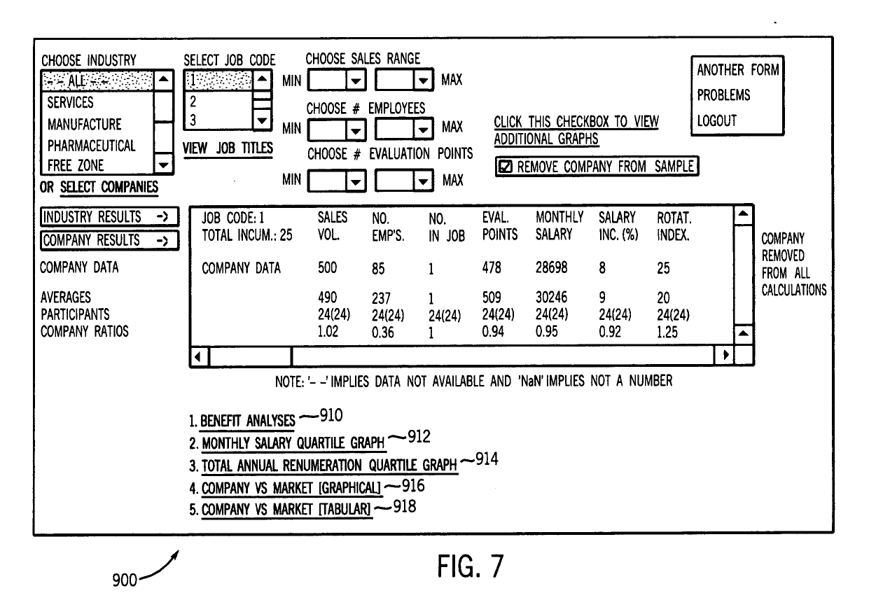

In one embodiment, the third option can be the graphical analysis option. The graphical analysis option enables the user to view market data and compare company verses market data. Referring to FIG. 7, the graphical analysis option page 900 is seen.

When selecting this option, the user will again select industries or companies to be compared. After making that selection, the corresponding data will appear on the screen, after clicking on Industry Results. In a preferred embodiment, three additional options can be presented: Benefit Analyses 910, Monthly Salary Quartile Graphs 912, and Total Annual Remuneration Quartile Graphs 914. Then, after clicking again on Industry Results and if the company is removed from the sample, as discussed above, two more options appear: Company versus Market (Graphical) 916 and Company versus Market (Tabular) 918.

For example, the graphical analysis option page 900 of FIG. 7 shows this information for job code 1—human resource administrator in the category all companies, with the company removed from the sample.

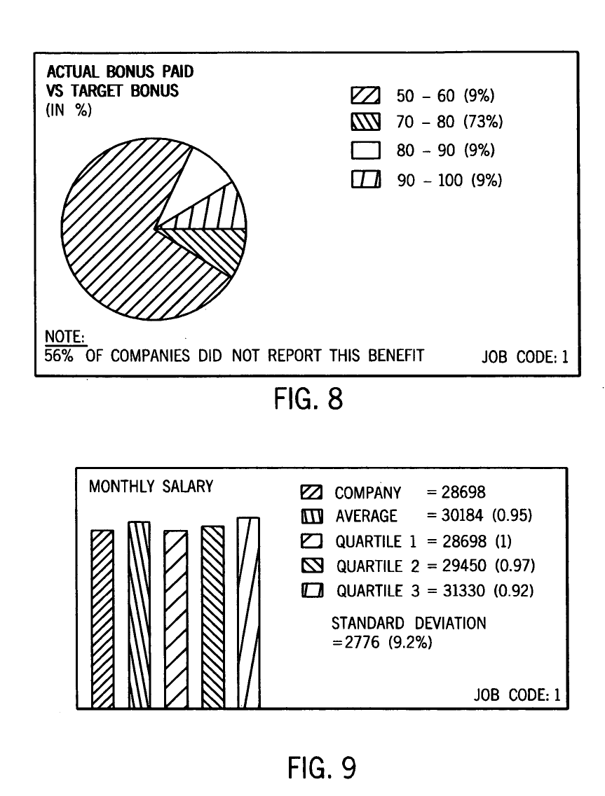

If the user selects the benefit analysis option a series of graphs that display the proportion of companies that provide the different benefits is provided. Each graph explains the terms on which the benefit is offered. For example, referring to FIG. 8, one of those graphs shows the relationship between Actual Bonuses Paid and Target Bonuses.

If the line Monthly Salary Quartile Graphs is clicked, several bar graphs will appear. The first bar graph corresponds to Company Monthly Salary for the job under analysis. An example of the Company Monthly Salary for the job under analysis is seen in FIG. 9. In a preferred embodiment, remaining bar graphs can include Market Average, First Quartile, Second Quartile, and Third Quartile. Also shown are the proportions of company values with respect to the market.

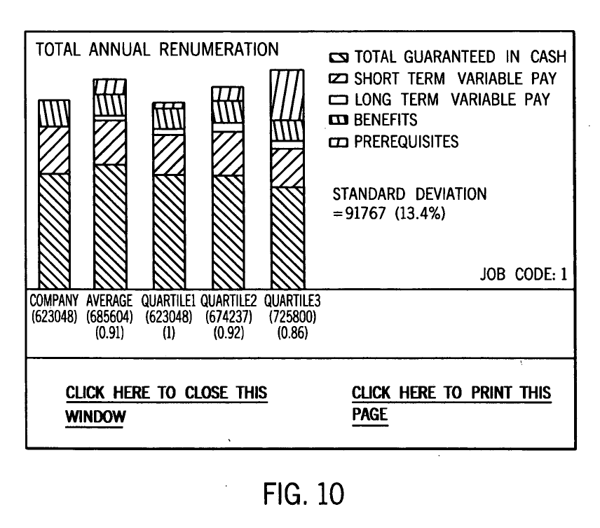

When clicking the Total Annual Remuneration Quartile Graphs, the bar graphs that appear are Company Data compared with the market Average and Quartiles. An example of the Company Data compared with the market Average and Quartiles for the job under analysis is seen in FIG. 10. In a preferred embodiment, the total remuneration bar graphs can be broken into Guaranteed Cash, Short Term Variable Pay, Long Term Variable Pay, Value of Benefits and Value of Prerequisites. The last two elements can be in the grossed-up value from net of taxes.

The divisions of the different components of total annual remuneration are not intended to show the actual values of each of the components, but rather the proportion of each with respect to the total. Both Quartile Graphs also show the standard deviations of the sample, but these graphs, and consequently the standard deviations, change as the user selects a different set of companies to be compared.

In accordance with the principles of the present invention, the system can show a summary of the company's position with respect to the market, considering all the jobs for which the company has provided data. The company can thus obtain a quick overall picture of its standing with respect to the market. However, to make corrective decisions, if required, the company as to do it on a job by job basis.

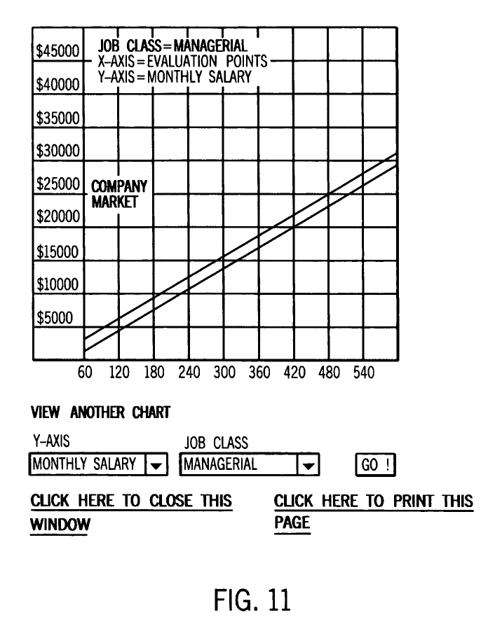

If the user clicks on Company Versus Market (Graphical), two linear regression lines will appear, one for the Company and one for the Market. An example of the Company Versus Market (Graphical) is seen in FIG. 11. The user has the possibility of shifting from Monthly Salary to Total Annual Remuneration, and also from Managerial Jobs to Administrative and Operation jobs. For this the user selects Y Axis (Monthly Salary or Total Annual) and/or Job Class (Managerial, Administrative or Operation) and then press Go.

The graphs can be calculated as linear regressions in which on the Y axis can be the remuneration and the X axis can be the evaluation points, both for the company and the market averages.

The Company Versus Market (Tabular) option presents the same information but the data of each position, both at the Company and the Market, appears in tables instead of graphs. An example of the Company Versus Market (Tabular) is seen in FIG. 12. Upon opening this option, the user will see a Serial Number of Jobs, the Job Codes, and the Company Data. Upon pressing on the serial number the Market Data will appear. Again, in this case the user can opt for Monthly Salary or Total Annual Pay, by pressing on the $ Parameter, and for Managerial, Administrative and Operation jobs by pressing on Job Class and then press Go.

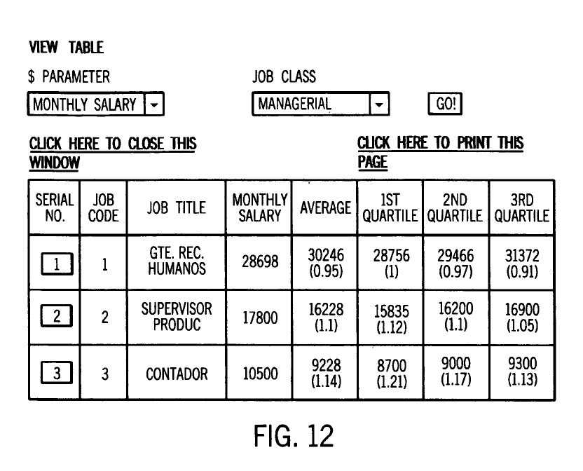

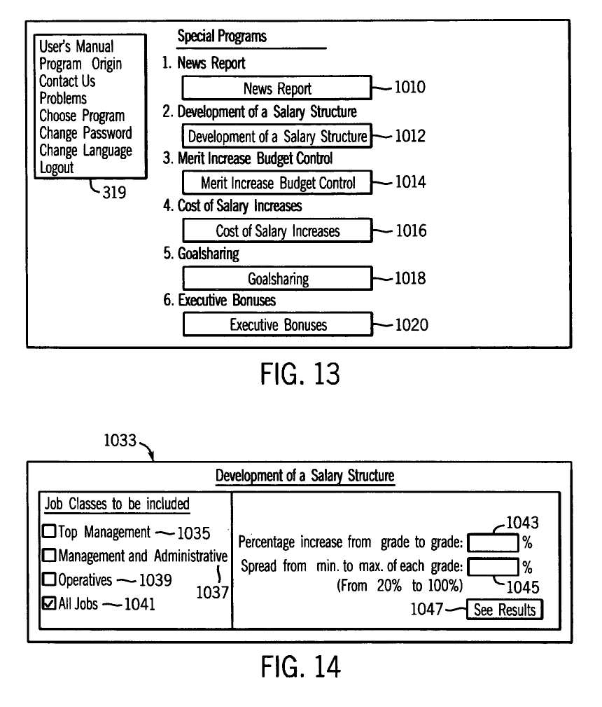

In one embodiment, the fourth option can be the special programs option. These special programs do not present market data. The special programs option provides information of special interest to human resource, compensation, and benefit managers, and the like, and also illustrates techniques that can be of unique value for remuneration administration programs. Referring to FIG. 13, the special programs option page is seen. In one embodiment, the special programs include News Report 1010, Development of a Salary Structure 1012, Merit Increase Budget Control 1014, Cost of Salary Increases 1016, Goalsharing 1018, and Executive bonuses 1020. The News Report 1010 option links to a new report page carrying bulletins that provides news of interest to human resource, compensation, and benefit managers, and the like. The news can be extracted from leading sources in the United States and other countries. The bulletin is updated every two or three weeks, so during the life of an annual subscription the user has the opportunity of seeing several of these bulletins. In one embodiment, the News Report 1010 option can link to a new source web-site, for example.

Selecting Development of a Salary Structure 1012 in the special programs option page links to a Development of a Salary Structure page seen in FIG. 14. In this special program, the jobs that a company reports can be classified into a salary structure designed specifically for the company. The user has to make several selections: the user decides which jobs are to be included. The Development of a Salary Structure page can include a category of job classes to be included 1033 which can include, for example, top management 1035, management and administrative 1037, operatives 1039, and all jobs 1041. The user can also select more than one of the groups at one time.

The user selects the desired percentage increment between grades 1043. This selection can be any reasonable increment, which can range for example from 5% to 25%, or even more, if desired. Finally, the user selects the spread he/she wishes from minimum to maximum of each grade 1045, which can range for example from 20% to 100%. Upon the user designating the percentage increase from grade to grade and the spread form minimum to maximum for each grade, the user can select the See Results link 1047.

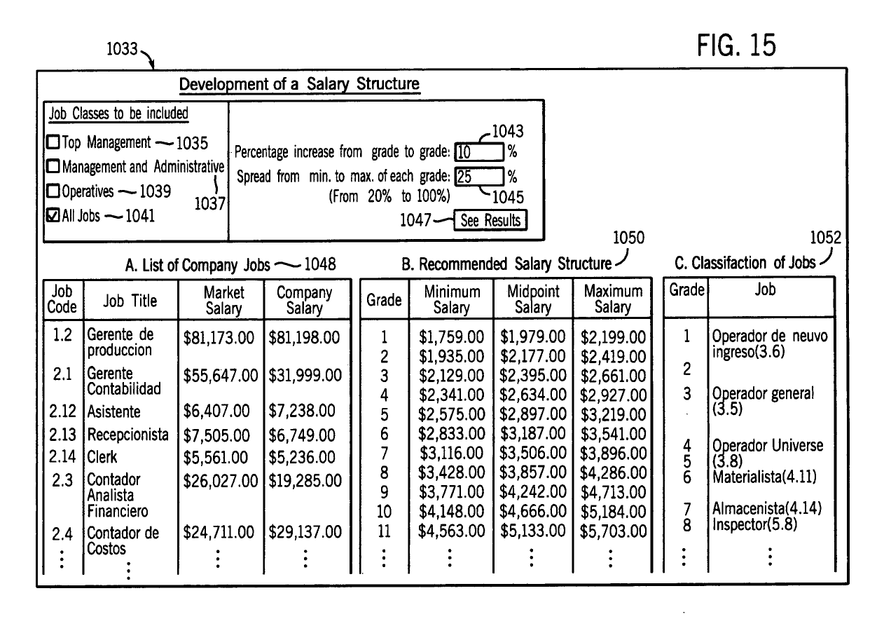

The user then sees the Development of a Salary Structure results page, an example of which is seen in FIG. 15. The Development of a Salary Structure results page can continue to display information from the Development of a Salary Structure page seen in FIG. 14. The Development of a Salary Structure results page can include three categories of results: a List of Company Jobs category 1048, a Recommended Salary Structure category 1050, and a Classification of Jobs category 1052. The Recommended Salary Structure category 1050 begins at the lowest paying job and goes as high as the highest paying job of the group selected, marketwise. The Classification of Jobs category 1052 considered in the designed structure. The user can experiment with as many options as desired, and print the different results for subsequent analysis.

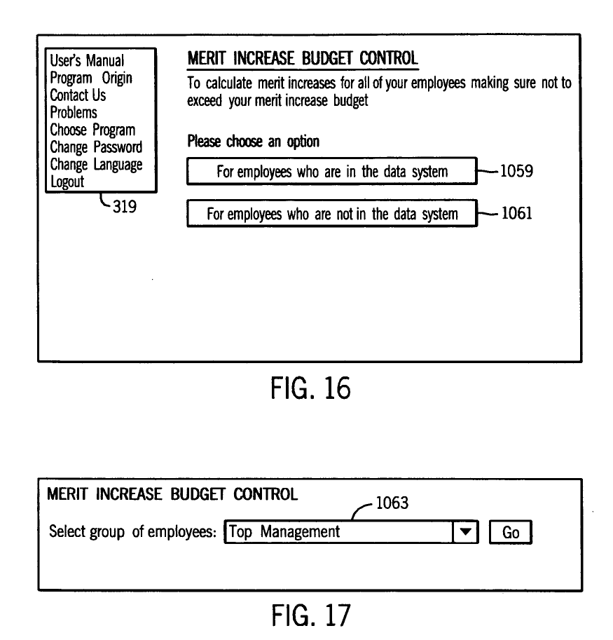

Referring back to FIG. 13, selecting Merit Increase Budget Control 1014 from the special programs option page links to a Merit Increase Budget Control page seen in FIG. 16. When a company grants merit increases to its personnel, the company runs the risk of having the total increases be off the specific budget for the purpose. This special program advises the company on how to grant these increases and stay within budget. In the Merit Increase Budget Control page, the user has two options: for employees who are in the data system 1059 and for employees who are not in the data system 1061. Selection of the option for employees who are in the data system 1059 links to a merit increase budget control employees page seen in FIG. 17, where the user designates the group of employees from a drop down menu 1063, for example, top management, management and administrative or management and management and administrative. Selection of the option for employees who are not in the data system 1061 allows the user to add employees to the data system.

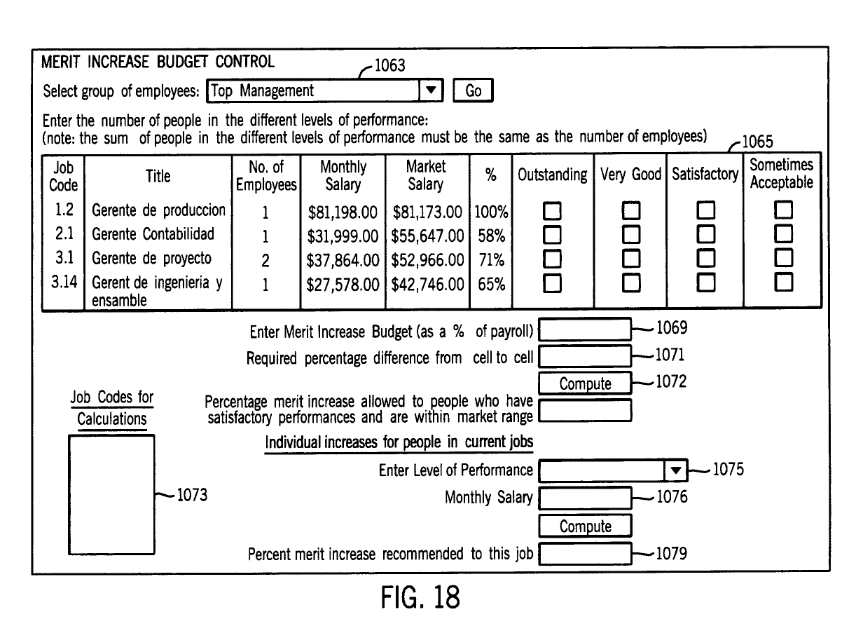

Either after selecting the group of employees in the merit increase budget control employees page or adding employees in the option for employees who are not in the data system, the user links to the merit increase budget control calculation page seen in FIG. 18. The merit increase budget control calculation page displays a table 1065 in which the jobs in the selected group appear. This table can include for example the Job Code, the Title of the Job, the Number of Employees in the Job, the Average Salary for the employees in the job, the Market Salary and the % of Actual Salary with respect to Market. The table 1065 can be scrolled down to its end.

For employees whose salaries are not in the system, the user has to provide not only the level of performance but also the Job Titles (an initial may suffice), the Number of People in the Job, the Average Monthly Salaries for those in the Job, and the Mid-Points of the Grades in which the particular jobs can be classified. Since no market data for those jobs exists, the merit increase control can be made with respect to the mid-point of the respective grades.

In this special program, increases can be granted based both on Merit and on Position with Respect to the Market, for example. A bi-dimensional matrix can be provided that has five levels of performance on the horizontal axis (Outstanding, Good, Satisfactory, Sometimes Acceptable and Poor) and three levels of location with respect to the market in the vertical axis (Below 95% of Market, Market, and Above 105% of Market). This matrix generates for example fifteen cells of personnel. The center cell—At Market with Satisfactory Performance—can be called the Center of Gravity of the Matrix, and it dictates the pattern for the increases.

The user has the option of selecting increases that can be higher and lower than those of the Center of Gravity, on the understanding that the higher the merit the larger the increase it should be, and the lower the position in the market the higher the increase it should be. For instance, if for the Center of Gravity the increase is, say for example 4%, and the user has selected a 2% difference between cells, the increase for the next higher level of performance and still within market should be 6%, and for a lower level of performance it should be 2%. Likewise, for a person below market but satisfactory performance the increase should also be 6%, which is 2% above the Center of Gravity increase. For employees with satisfactory performance but above market the increase should be 2%, or 2% below the Center of Gravity. It can be inferred from this that the highest increase granted is for somebody with Outstanding Performance and Below Market, who is three cells separated from the Center of Gravity. If the Center of Gravity is 4%, this person would receive 10%, provided the difference between cells is 2%. The position with respect to the market can be generated automatically by comparing the company data with the market data. The performance of each individual, however, has to be provided by the company, as seen in FIG. 18.

In front of each of the jobs, the user selects a level of performance, which can be for example Outstanding, Very Good, Satisfactory, Sometimes Acceptable or Poor. Next, the user must select which is the company's Merit Budget 1069, expressed as a percentage of the Annual Payroll, and also provide how much Difference in Salary Increase 1071 is desired between cells, as described above. This difference can be from 1% to as many percentage points as desired or warranted. Then by pressing Compute 1072, the program will tell the user the increase that should be granted to employees in the Center of Gravity, or employees that are at market and their performance is satisfactory. It is recommended, however, that at the beginning the user try with a small percentage between cells, until the increase for the Center of Gravity is known. This percentage can then be modified, if warranted, in subsequent tries.

Once the increase for the Center of Gravity is known, the increases for the different individuals in the jobs can be calculated taking one job at a time. For this the user selects the proper job from drop down menu under Job Codes for Calculations 1073. This will record the job's salary in the rectangle labeled Monthly Salary 1076. Next, the user enters the level of performance of the employees in that job from drop down menu 1075, which must be the same as the performance earlier, and the program will provide the appropriate merit increases 1079. By following this procedure for all jobs, the individual increases will be separated cell by cell by the percentage point established at the outset, and the sum of all individual increases will be within the established budget.

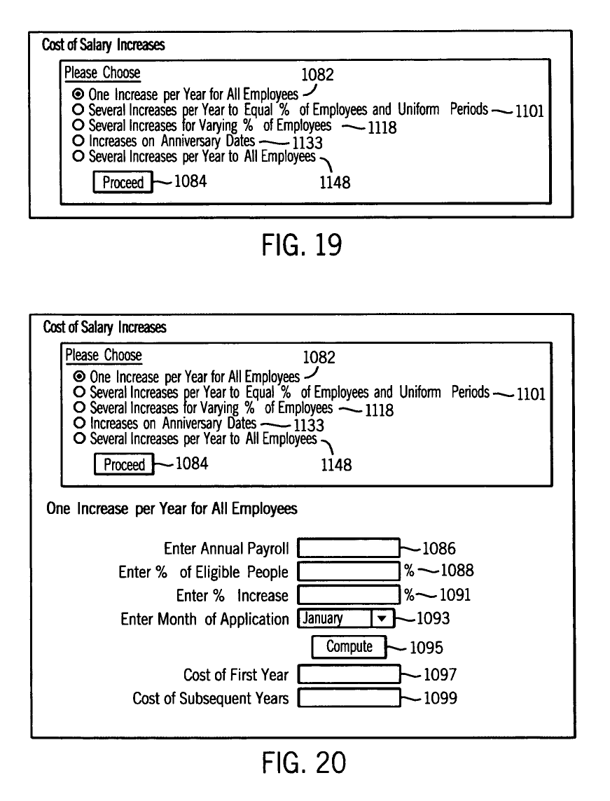

Referring back to FIG. 13, selecting Cost of Salary Increases 1016 from the special programs option page links to a Cost of Salary Increases page seen in FIG. 19. Costing of salary increases can be tricky. This special program calculates the cost of different scenarios of increases and separates the Cost for the First Year and for Subsequent Years. An increase granted a certain year costs not only the year it is granted, but continues costing in subsequent years, although differently. The first year the increase is effective as of a certain month, which can be January or not; for subsequent years it is always effective from the beginning of the year.

One case of increase is when there is one increase per year for all employees, applicable as of a certain month of the year. For this the user clicks on One Increase per Year for all Employees 1082 and then clicks Proceed 1084. Referring to FIG. 20, a One Increase per Year for all Employees page is seen. The user has to provide the Annual Payroll 1086, the Percentage of People that are Eligible 1088 (some companies don't grant increases unless the employee has been employed a minimum of a specified number of months), the Increase to be Granted 1091 and from a drop down menu the Month of the Year the increase becomes effective 1093. Upon pressing Compute 1095 the program provides the cost of the first year 1097 and of subsequent years 1099.

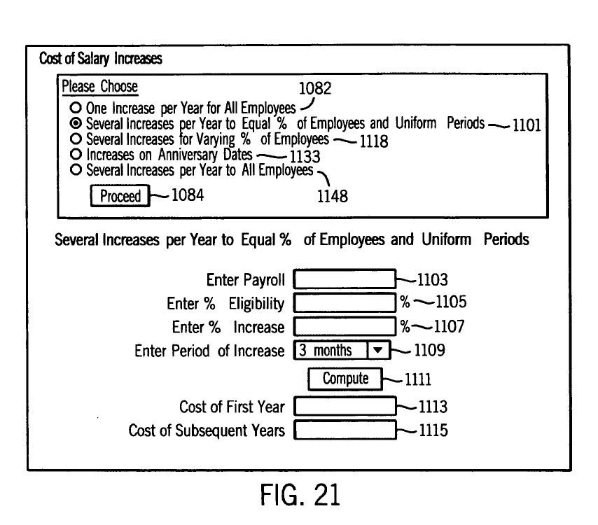

Another case is when employees receive increases at equal intervals, such as every quarter. The percentage of employees receiving such increases remains constant. For example, if a company grants increases every quarter, then 25% of the employees receive increases every quarter. If it is every four months, 33.3% of employees receive increases, and so on. For this the user clicks on Employees Receive Increases at Equal Intervals 1101 in FIG. 19 and then clicks Proceed 1084. Referring to FIG. 21, an Employees Receive Increases at Equal Intervals page is seen. The user provides the Annual Payroll 1103, the Percentage of People that are Eligible 1105, the Percentage Increase to be Granted 1107, and from a drop down menu the Frequency of Increases 1109. It can be assumed in this case that all increases for the period become effective the first day of the period. Upon pressing Compute 1111, the program provides the cost for the first year 1113 and for subsequent years 1115.

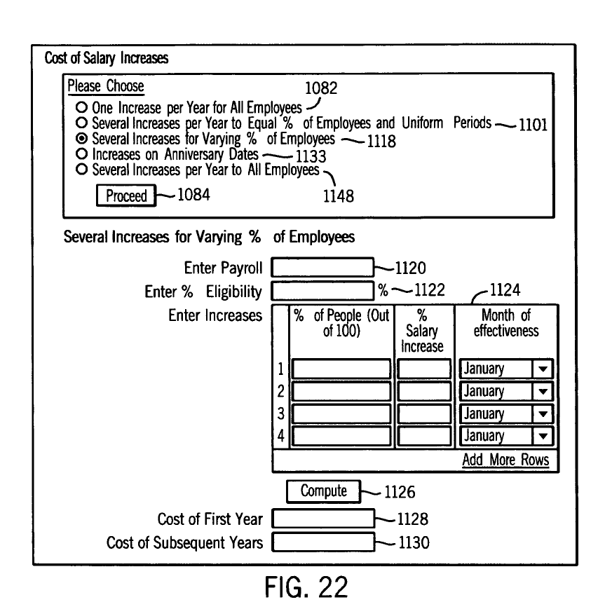

Another case is when the company provides several increases for varying percentage of employees. For this the user clicks on Several Increases for Varying % of Employees 1118 in FIG. 19 and then clicks Proceed 1084. Referring to FIG. 22, a Several Increases for Varying % of Employees page is seen. For this the user provides the Annual Payroll 1120, the Percentage of People that are Eligible 1122, and the Percentage of Increase to be Granted to a Certain Percentage of Personnel 1124, effective a certain date of the year. The percentages of employees in the different periods adds up to 100% during the year. For example, the company may wish to grant 4% increase to 50% of the employees effective March 1^{st}; 5% to 35% of the employees effective July list; and 5% to 15% of the employees effective September 1^{st}. Upon pressing Compute 1126, the program provides the cost for the fist year 1128 and for subsequent years 1130.

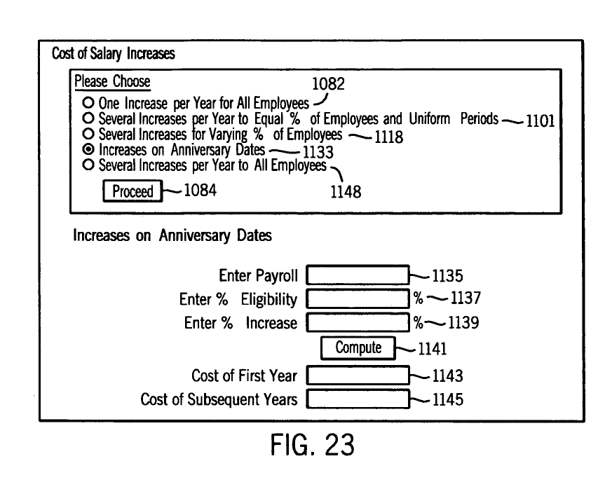

Some companies provide increases on anniversary dates. For this the user clicks on Increases on Anniversary Dates 1133 in FIG. 19 and then clicks Proceed 1084. Referring to FIG. 23, a Increases on Anniversary Dates page is seen. The user provides the Payroll 1135, the Percentage of Eligibility 1137 and the % Increase to be Granted on anniversary dates 1139. Upon pressing Compute 1141, the program gives the cost for the first year 1143 and for subsequent years 1145.

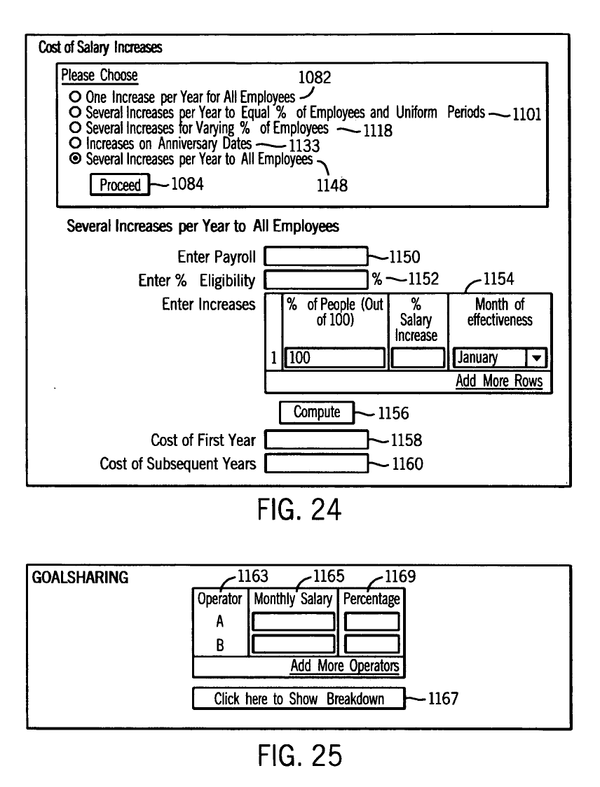

Finally, the program considers the possibility of a company that grants several increases during the year to all employees. For instance, a company may grant a 5% increase to all employees on March 1^{st}, then an additional increase of 3% effective July 15^{th}, and a third increase of 3% effective October 15^{th}. For this the user clicks on Several Increases During the Year but for the Same People 1148 in FIG. 19 and then clicks Proceed 1084. Referring to FIG. 24, a Several Increases During the Year but for the Same People page is seen. The user provides the Annual Payroll 1150, the Percentage Eligibility 1152, and the Different Percent Increases to be Granted During the Year 1154, indicating the date they become effective. Upon pressing Compute 1156, the program provides the cost for the first year 1158 and for subsequent years 1160. The user has to keep in mind that after the first increase the annual payroll grows by the percentage of the first increase; it grows again after the second increase, and so on.

Referring back to FIG. 13, selecting Goalsharing 1018 from the special programs option page links to a Goalsharing page seen in FIG. 25. In this special program, the company can select a series of measurements and establishes a goal for a group of employees. Beyond that minimum the company is willing to share benefits with the employees affected, in the proportion of the company's choosing or whatever proportion can be agreed upon with the employees. While the number of measurements can vary, it is recommended that no more than three be used at any one time. The measurements can include, for example, production (e.g., in excess of certain level); maintenance cost (e.g., below a certain level); downtime of equipment (e.g., measured in time); customer satisfaction (e.g., measured in number of complaints); number of rejects (e.g., number of pieces that don't meet quality standards); reduction in receivables; file simplification; and others.

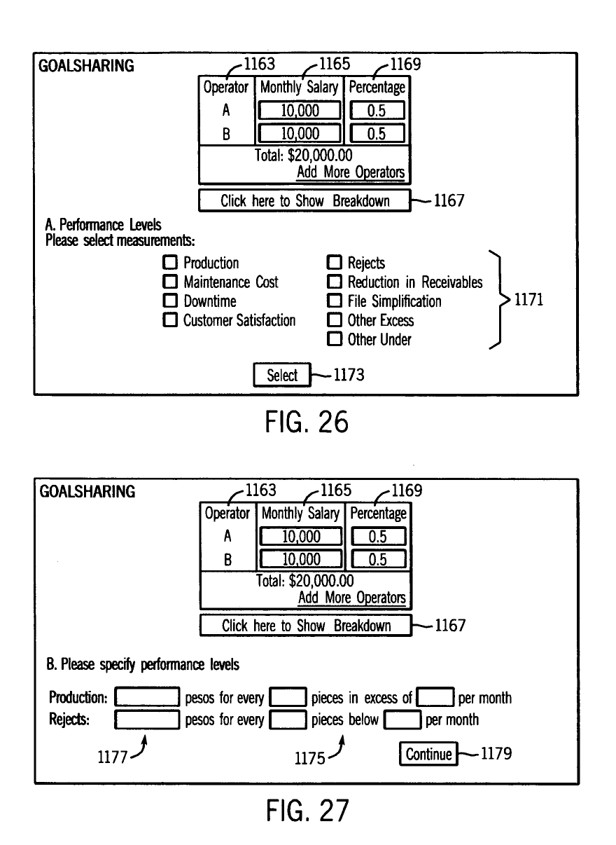

The company provides the names or initials of employees affected 1163 and their Monthly Salaries 1165. Upon clicking Click here to Show Breakdown 1167, the program will show the percentage the salary is of the total 1169. Referring to FIG. 26, the company selects the measurements 1171 and clicks Select 1173. Once the measurements are selected, the corresponding Performance Level 1175 and the Bonus if Levels are Exceeded 1177 can be entered. Referring to FIG. 27, the user enters the Performance Level and the Bonus if Levels are Exceeded. For example, the company might say: 1000 Pesos for every 100 pieces in excess of production over so many per month; or 1500 Pesos for every 10 pieces rejected below a certain maximum per month, and so on. Once all levels and bonuses are entered, the user clicks Continue 1179.

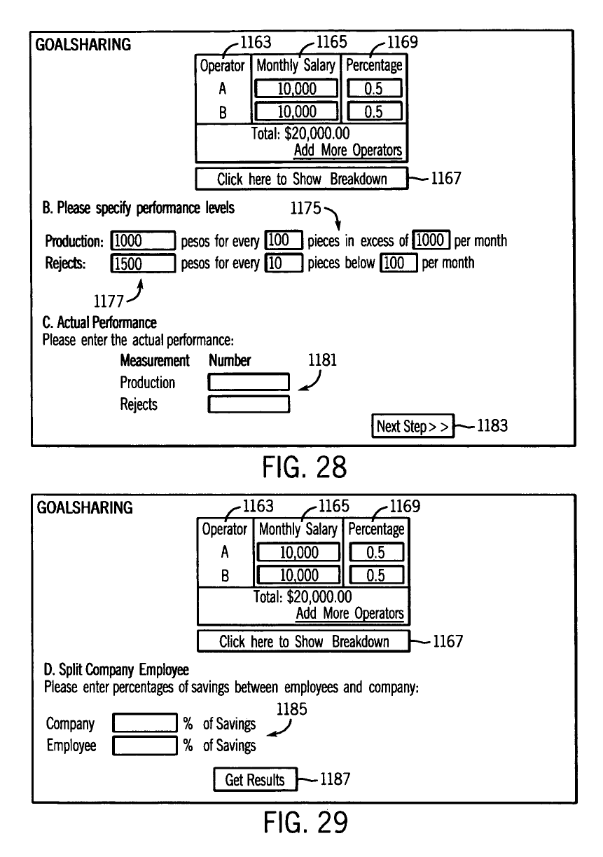

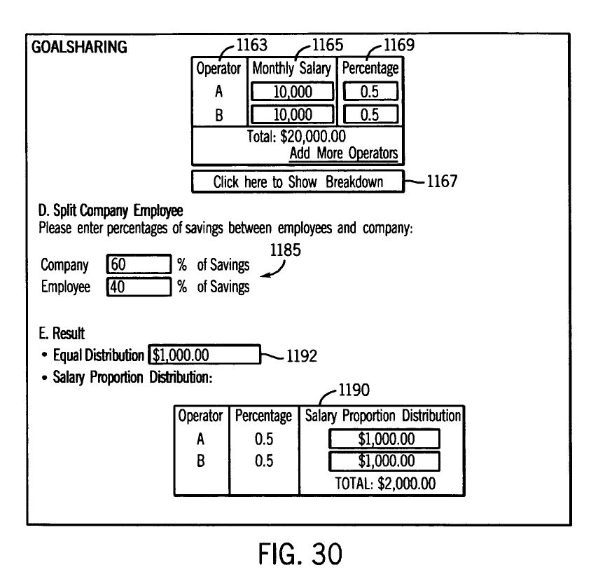

Next, the actual results of each of the measurements can be entered. Referring to FIG. 28, the user enters the Actual Results of Each of the Measurements 1181 and clicks Next Step 1183. Finally, the percentage of savings the company is willing to share with employees can be entered. Referring to FIG. 29, the user enters the Percentage of Savings 1185 and clicks Get Results 1187. Referring to FIG. 30, the Goalsharing results are displayed. This special program indicates the bonus to be given to each individual 1190 in accordance to the terms selected. The answer can be provided in two forms: Equal Distribution to all Employees 1192 and Distribution in Proportion to their Salaries 1190.

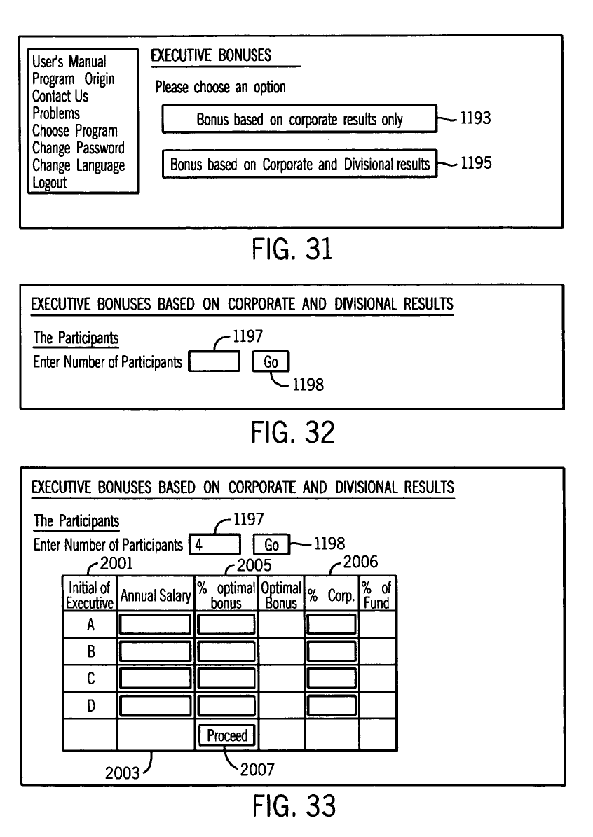

Referring back to FIG. 13, selecting Executive bonuses 1020 from the special programs option page links to an Executive bonuses page seen in FIG. 31. Executive bonuses can be a very delicate issue. When companies issue bonus to executives, they must base them on some parameters that are indicative of the year-end results. These parameters can vary, at the option of the company, such as return on equity, return on assets, return on sales, market penetration, growth, profits or any other parameter the company might deem pertinent. The company can select any number of these parameters at once, but it is advisable not to use more than three at one time. Before proceeding, the user selects whether the bonuses will be based on Corporate Results only 1193, or on Corporate and Divisional Results 1195. For ease of description, Corporate and Divisional Results will be described.

Referring to FIG. 32, for Corporate Results only the user enters the number of employees that participate 1197. This is not the number of employees that might be subject to bonuses, but the number that will be engaged in the bonus program being designed. Other employees, executives or not, might be subject to other bonus programs, which can be developed one at a time. Most of the bonus programs, however apply to executives.

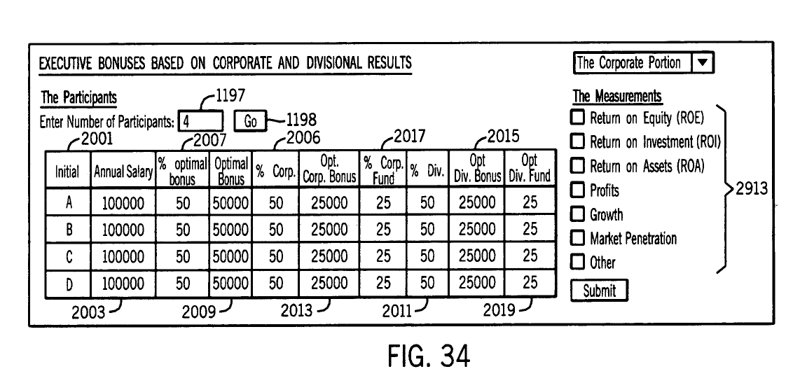

Once the number is entered and Go 1198 is selected, the page seen in FIG. 33 appears. This page includes as many lines as the number of employees that participate, and also shows initials for each executive 2001. The user enters the Annual Salary of each executive 2003, the Percentage of Salary each executive can receive as Optimal Bonus 2005 and the Optimal Bonus attributed to Corporate 2006. After pressing Proceed 2007, the program will calculate the amount of the optimal bonuses 2009, the amount of the Optimal Bonus attributed to Corporate 2013, the amount of the Optimal Bonus attributed to Divisional 2015, the percent corporate funded the Optimal Bonus 2017, the percent divisional funded the Optimal Bonus 2019 and the percentage of Optimal Bonus attributed to Divisional 2011, seen in FIG. 34.

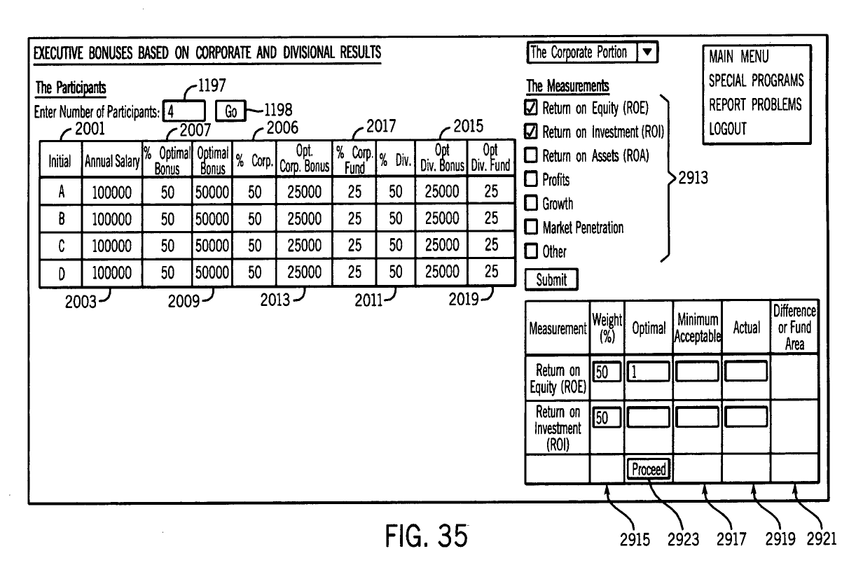

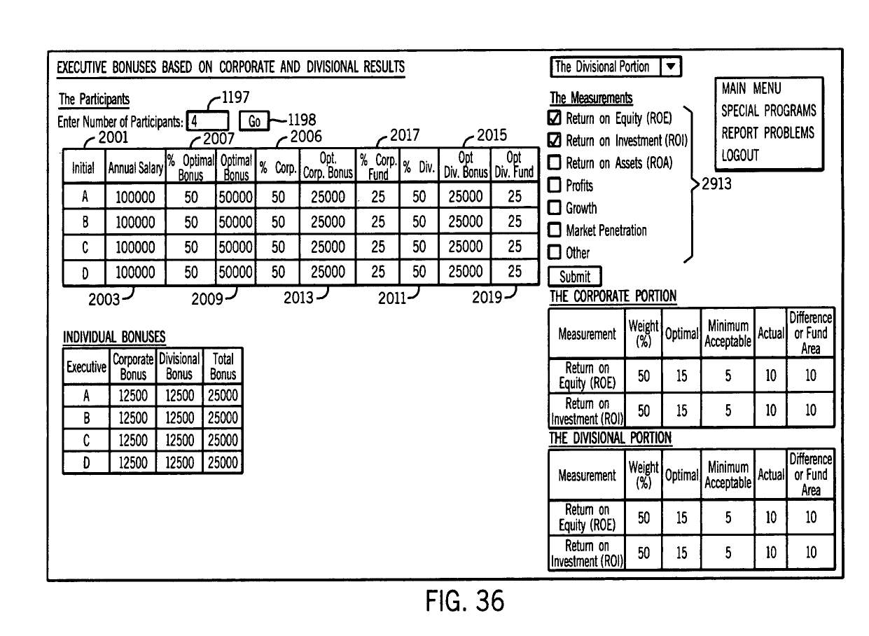

The user selects the measurements 2913. This can be any number, but it is recommended that no more than three measurements can be selected and submitted. As seen in FIG. 35, a new page appears that includes the measurements selected. The user enters the Weight of the Measurement 2915, the Optimal Performance 2917, the Minimum Acceptable Performance 2919, and the Actual Performance 2921. The weight of the measurement indicates what is the impact percentage of that particular measurement on the total bonus. When selecting the weight of each measurement, the user must be careful that the sum of the weights of all measurements selected adds to 100%. If only one measurement is selected its weight is automatically 100%. The bonus program is predicated on the idea that an optimal performance would produce an optimal bonus, but that no bonus will be provided if the actual performance falls below the minimum acceptable performance. Upon entering the data, the special program will provide the amount of bonus each executive is entitled to after pressing Proceed 2923, as seen in FIG. 36.

While the invention has been described with specific embodiments, other alternatives, modifications and variations will be apparent to those skilled in the art. Accordingly, it is intended to include all such alternatives, modifications and variations set forth within the spirit and scope of the appended claims.

1. A computer networked compensation analysis method comprising:
designating a group of employees of a company;
determining an at market with satisfactory performance level;
selecting a level of performance;
establishing a merit budget of the company and providing a difference in salary increase;
selecting increases that are higher and lower than those of the at market with satisfactory performance level; and
advising the company on how to grant these increases and stay within budget.

2. The computer networked compensation analysis method of claim 1 further comprising providing a bi-dimensional matrix that has levels of performance on one axis and levels of location with respect to the market in another axis.

3. The computer networked compensation analysis method of claim 1 further wherein the levels of performance are selected from the group comprising outstanding, good, satisfactory, sometimes acceptable and poor.

4. The computer networked compensation analysis method of claim 1 further comprising wherein levels of location with respect to the market are selected from the group comprising low 95% of market, market, and above 105% of market.

5. A computer networked compensation analysis method comprising:
selecting a category of pay increases; and
calculating the cost of different scenarios of increases for the first year and for at least one subsequent year.

6. The computer networked compensation analysis method of claim 5 further comprising selecting a category of pay increases from the group comprising one pay increase per year for all employees, pay increases applicable as of a certain month of the year, employees receive pay increases at equal intervals, several pay increases for varying percentage of employees, pay increases on anniversary dates, and several increases during the year but for the same people.

7. A computer networked compensation analysis method comprising:
selecting a performance level and a bonus if the performance level is exceeded;
entering the results of measurements of the performance level;
entering a percentage of savings the company is willing to share with employees; and
calculating the bonus to be given to individual employees.

8. The computer networked compensation analysis method of claim 7 further comprising selecting a performance level from the group comprising production; maintenance cost; downtime of equipment; customer satisfaction; number of rejects; reduction in receivables; file simplification; and combinations thereof.

9. A computer networked compensation analysis method comprising:
entering the annual salary of each executive and the percentage of salary each executive can receive as an optimal bonus;
calculating the amount of the optimal bonuses and the proportion of the total bonus fund each bonus represents;
selecting a measurement;
weighing the measurement;
entering the actual performance; and
calculating the bonus to executives.

10. The computer networked compensation analysis method of claim 9 further comprising designating an optimal performance and a minimum acceptable performance

11. The computer networked compensation analysis method of claim 9 further comprising selecting a measurement from the group comprising return on equity, return on assets, return on sales, market penetration, growth, profits, and combinations thereof.

12. The computer networked compensation analysis method of claim 9 further comprising basing bonuses corporate results only.

13. The computer networked compensation analysis method of claim 9 further comprising basing bonuses on corporate and divisional results.

14. A computer networked compensation analysis method comprising:
selecting which jobs of a company are to be included;
selecting the desired percentage increment between job grades;
selecting the spread of each job grade; and
classifying into a salary structure designed specifically for the company.
